(19) United States
(12) Patent Application Publication
(10) Pub. No.: US 2025/0370109 A1
(43) Pub. Date: Dec. 4, 2025

(54) LONG TAIL REMOVAL IN DIRECT TIME OF FLIGHT RETURNED PULSE ANALYSIS

(71) Applicant: STMicroelectronics International N.V., Geneva (CH)

(72) Inventors: Victor Macela, Paris (FR); Thierry Lebihen, Bourg la Reine (FR)

(21) Appl. No.: 19/187,340

(22) Filed: Apr. 23, 2025

(30) Foreign Application Priority Data
May 29, 2024 (EP) 24305844.3

(51) Int. Cl. G01S 7/497; G01S 7/4861; G01S 7/4865; G01S 17/04

(52) U.S. Cl. CPC G01S 7/497; G01S 17/04; G01S 7/4861; G01S 7/4866

(57) ABSTRACT

According to an embodiment, a method detects objects within a field of view of a time-of-flight sensor by processing photon arrival time distributions. The method obtains a current histogram generated by the time-of-flight sensor and provides a pre-computed nominal global pulse shape, including reference and correction parts. After fitting the reference part to the current histogram, the method determines the position of a long tail part using the relative positioning of the correction part to the reference part. The method calculates the long tail (LT) distribution estimate and corrects the current histogram.

### CROSS-REFERENCE TO RELATED APPLICATIONS

This application claims the benefit of European Application No. 24305844.3, filed on May 29, 2024, which application is hereby incorporated by reference herein in its entirety.

### TECHNICAL FIELD

Some embodiments of the disclosure relate to "Time of Flight" (ToF) devices (either dToF: direct Time of Flight or iToF: indirect Time of Flight devices).

### BACKGROUND

Devices for determining the distance (or range) to objects or targets are known. One currently used method is "Time of Flight" (ToF). This method involves sending a light signal toward the object and measuring the time the signal travels to the object and back to the device.

Direct Time-of-Flight (dToF) devices directly measure the time the signal takes to travel to the object and back to the device. Indirect Time-of-Flight (iToF) devices calculate the time the signal takes for this travel by measuring the phase shift between the signal coming out of the light source and the signal reflected from the object and detected by a light sensor. Knowing this phase shift and the speed of light enables the determination of the distance to the object.

Single photon avalanche diodes (SPAD) may be used to detect the reflected light pulse. A photon may generate a carrier in the SPAD through the photoelectric effect. The photo-generated carrier may trigger an avalanche current in one or more of the SPADs in a SPAD pixel array. The avalanche current may signal an event, namely that a photon of light has been detected.

To produce accurate timing information on the arrival of each photon originating from the optical light radiation, single-photon sensitive detectors may be adapted to generate time-series histograms of the number of photons detected during successive emission periods.

Thus, such time-series histograms are constituted by several bins, each associating a number of detected photons to a given acquisition time during the emission periods.

Some bins of such histograms may be representative of photons originating from the radiation reflected by an object. Hence, these bins represent an object's presence within the field of view of the time-of-flight sensor. Generally, these bins have a number of photons greater than a given threshold below which the number of detected photons is the one of an ambient noise.

Algorithms are implemented to identify the bins of the histograms that are representative of photons originating from the radiation reflected by one or several object(s).

In particular, it is possible to identify the bins that are representative of the presence of an object by comparing the bins with a fixed threshold greater than or equal to the given threshold delimiting the ambient noise. The ambient noise typically designates the background noise originating from the lightening conditions of use of the sensor (in typical ToF application, the infrared “ambient” light which is not emitted by the emitter).

Nevertheless, the classical identification algorithms may be insufficient to correctly identify the bins representative of an object's presence and those not, with respect to the reality of the scene, called “ground truth.”

FIG. 1 illustrates a histogram (HST0) that may be generated by a classical ToF sensor. The histogram (HST0) depicts bins in ordinates as the number of detected photons (NB) per acquisition time, the acquisition time (AT) being represented in the form of bin numbers in abscissas.

From the signal returned by the object of the ground truth, the Time of Flight device generates a global distribution of bins (i.e., a histogram), defined as the “global pulse,” whose first part is the “useful pulse” (the pulse UP). The useful pulse (UP) is typically followed by an undesirable distribution of bins, called “long tail,” shaped with a progressive decrease in the number of detected photons. Bins of the long tail (LT) distribution are not representative of photons originating from a radiation reflected by an object. They may, nevertheless, be higher than the threshold of ambient noise (AN).

In addition, the long tail (LT) can vary in intensity and shape according to the amplitude of the useful pulse (UP) and the function of some other parameters such as the temperature.

The long tail (LT) can be the result of various phenomena, originating in the emitter (e.g., at the Vertical-Cavity Surface-Emitting Laser “VCSEL” driver) or the receiver (e.g., the after-pulsing effect).

On the one hand, ignoring the bins of the long tail (LT) distribution may occult a secondary pulse located in this tail (i.e., part of the same ranging measurement). The secondary pulse may represent the presence of another object, which would not thus be detected.

On the other hand, considering the bins of the long tail (LT) distribution as a useful signal may lead to false positive detections. Too many false positives to process can lead to a drop in the frame rate at close distances and a non-uniform frame rate from close to far distances.

Conventional Expectation-Maximization algorithms could be used for whatever parametrizable pulses in a histogram to recognize and correct the undesired long tail (LT) distribution. However, the use of Expectation-Maximization algorithms would be unrealistic because it is far too complex in terms of computation for real-time embedded sensors, and that also supposes that the long tail (LT) distribution is easily parametrizable with a reasonable number of parameters (which is not straightforward to assume).

Hence, there should be an effective method for detecting the presence of an object reliably.

### SUMMARY

According to embodiments a solution is proposed to dispense with these undesirable long tail (LT) distributions or to compensate for them; the solution allows to rapidly remove or compensate for a long tail in the return histogram, allows to simplify the pulse detection algorithm, and, by restricting the processing to the real pulses, it allows to maintain a high enough frame rate at low distances and a regular frame rate over the range of distances.

According to a particular embodiment it is proposed to precompute a global pulse shape (i.e., the shape of a histogram generated from a unique object in the field of view of the sensor) and separate it into a precomputed reference part and a precomputed correction part; fit the precomputed reference part (or possibly the precomputed global pulse shape) to the current histogram in order to determine the position of the long tail part of the current histogram, this determination using the known position of the correction part relatively to the reference part inside the precomputed global pulse shape; providing a final estimate of the long-tail-only distribution (i.e., without any secondary pulses representative of the presence of another objects) inside the long tail part of the current histogram, this final estimate being calculated from the precomputed correction part, the calculation possibly including to adjust the precomputed correction part to the long tail part of the current histogram by a second fitting (using the determined position of the long tail part); subtract from the long tail part of the current histogram the final estimate of the undesired long-tail-only distribution (or compensate for this distribution by using the final estimate in the used pulse detection algorithm).

According to an aspect, a method is proposed for detecting a presence of at least one object within a field of view of a time-of-flight sensor, comprising: obtaining a current histogram generated by the time-of-flight sensor, the histogram comprising a distribution of bins associating a number of detected photons to a given acquisition time, providing a precomputed nominal global pulse shape of the distribution, including a reference part and a correction part; performing a fitting of the position (e.g. a fitting in time) of at least the reference part to the current histogram; determining the position of a long tail part of the current histogram using the position of the correction part relatively to the reference part inside the precomputed nominal global pulse shape; calculating an estimate of a long tail (LT) distribution in the current histogram from the precomputed correction part and the determined position; and performing a correction, in the current histogram, of the calculated estimate of the long tail (LT) distribution.

In other words, it is proposed to fit the position of a precomputed global pulse shape, either fitted entirely or fitted only on its reference part, to provide an estimate of the long-tail distribution (i.e. the “long-tail-only” distribution without any secondary pulses representative of the presence of another objects) of the currently returned histogram, from the correction part of the precomputed shape of the long tail, and to correct the distribution by using this estimate.

Consequently, correcting the undesirable long tail (LT) distribution is performed very effectively in high accuracy and low computational consumption.

According to an embodiment, the step performing a position fitting includes an alignment in time of the entire nominal global pulse shape with the current histogram.

According to an alternative embodiment, the step performing a fitting of the position includes an identification in the current histogram of a useful pulse representative of the presence of an object, for example the part of the current histogram with the highest amplitude, and an alignment of the position (e.g. an alignment in time) of the reference part with the useful pulse of the current histogram.

According to an embodiment, the method additionally comprises performing a fitting in amplitude of the correction part to the long tail part of the current histogram.

According to an embodiment, the reference part of the precomputed nominal global pulse shape includes a shape of a nominal useful pulse.

According to an embodiment, the correction part of the precomputed nominal global pulse shape includes a shape of a nominal long tail including a progressively decreasing series of bins.

According to an embodiment, the method additionally comprises: emitting an optical radiation, counting photons detected from an optical radiation, generating the current histogram according to the count of detected photons over respective acquisition times, the acquisition times succeeding each other during an acquisition period starting with the emission of the optical radiation.

According to another aspect, a system is proposed, including a time-of-flight sensor adapted for detecting the presence of at least one object within a field of view, the system comprising a processing unit configured: to generate a current histogram comprising a distribution of bins associating a number of detected photons to a given acquisition time, to provide a precomputed nominal global pulse shape of the distribution, including a reference part and a correction part; to perform a fitting of the position of at least the reference part to the current histogram; to determine the position of a long tail part of the current histogram using the position of the correction part relatively to the reference part inside the precomputed nominal global pulse shape; to calculate an estimate of a long tail (LT) distribution in the current histogram from the precomputed correction part and the determined position; and to perform a correction, in the current histogram, of the calculated estimate of the long tail (LT) distribution.

According to an embodiment, the processing unit is configured to fit the position, including an alignment in time of the entire nominal global pulse shape with the current histogram.

According to an alternative embodiment, the processing unit is configured to perform the fitting of the position, including an identification in the current histogram of a useful pulse representative of the presence of an object and an alignment of the position of the reference part with the useful pulse of the current histogram.

According to an embodiment, the processing unit is additionally configured to perform a fitting in amplitude of the correction part to the long tail part of the current histogram.

According to an embodiment, the reference part of the precomputed nominal global pulse shape includes a nominal useful pulse (UP) shape.

According to an embodiment, the correction part of the precomputed nominal global pulse shape includes a shape of a nominal long tail including a progressively decreasing series of bins.

According to an embodiment, the system additionally comprises: emitting circuit configured to emit an optical radiation, receiving circuit configured to count photons detected from an optical radiation, and wherein the processing unit includes: histogram generation circuit configured to generate the current histogram according to the count of detected photons over respective acquisition times, the acquisition times succeeding each other during an acquisition period starting with the emission of the optical radiation.

### BRIEF DESCRIPTION OF THE DRAWINGS

Other advantages and features of the invention will appear upon examining the detailed description of non-limiting implementation and embodiments, and from the appended drawings wherein:

FIG. 1 is a histogram that may be generated by a classical ToF sensor;

FIG. 2 is a block diagram of an embodiment time-of-flight sensor;

FIG. 3 is a flowchart of an embodiment method for detecting the presence of at least one object.

FIG. 4 depicts example implementations for various steps of the method in FIG. 3;

FIG. 5 depicts the second fitting operation of the correction part to a long-tail part of the current histogram; and

FIG. 6 depicts the subtracting option for the correcting operation.

### DETAILED DESCRIPTION OF ILLUSTRATIVE EMBODIMENTS

FIG. 2 illustrates a block diagram of an embodiment time-of-flight sensor (SENS). The time-of-flight sensor (SENS) comprises an emitting circuit (ME) configured to emit optical radiations (RE) periodically. The emitting circuit (ME) may consist of a Vertical-Cavity Surface-Emitting Laser, commonly known to persons skilled in the art under the acronym “VCSEL.”

If one or several object(s) (OBJ) are present within the field of the optical radiation, the time-of-flight sensor (SENS) could receive a reflected optical radiation (RR) resulting from a reflection of the optical radiation on the object(s) (OBJ).

Thus, the time-of-flight sensor (SENS) comprises a receiving circuit (MR) configured to receive optical radiations (RR) reflected by the objects (OBJ) within the field of view of the time-of-flight sensor. The receiving circuit (MR) comprises photon detector(s), such as single photon avalanche diodes, classically known as “SPAD” by the person skilled in the art, that may be used as a detector of the reflected light pulses.

The time-of-flight sensor (SENS) comprises a histogram generation circuit (MGH) configured to generate a histogram from the signals output by the array of single photon detectors. In particular, the histogram generation circuit (MGH) is configured to count the number of photons detected by the receiving circuit at several successive acquisition times.

Thus, the histogram generation circuit (MGH) is configured to generate a histogram comprising different bins. Each bin associates a number of detected photons to a given acquisition time.

The generated histograms are not plotted in a graph, as the term “plot” may generally be used, while the term “to generate a histogram” is to be understood as storing an organization of data (possibly corresponding to a histogram organization) in a memory.

More particularly, a histogram is acquired over a given period. The bins of a histogram are associated with different acquisition times of the acquisition period of the histogram. The acquisition period of one histogram starts at the time of emission of an optical radiation by the emitting circuit and lasts until a predefined number of bins is acquired.

By “time,” it should be understood as a very short duration in comparison with the acquisition period of a histogram. For example, an acquisition time may last 250 picoseconds, and an acquisition period of a histogram may last 36 nanoseconds to acquire 144 bins.

Furthermore, it is also possible to acquire and sum up several histograms one after another. The overall acquisition period of these histograms may be in the range of 15 milliseconds.

In embodiments, the histogram generation circuit (MGH) is implemented by software instructions executed by a processing unit (UT) of the time-of-flight sensor. For example, the processing unit (UT) may be integrated into a microprocessor device.

The time-of-flight sensor (SENS) also comprises a processing circuit (MT) configured to post-process the generated histograms. Postprocessing allows for the determination of the bins that are representative of the presence of an object within the sensor's field of view. A bin distribution representative of the presence of an object allows for determining the distance between the object and the sensor by considering the acquisition time associated with the bins of this distribution.

Typically, the bin distribution representative of the presence of an object within the field of view of the sensor corresponds to a Gaussian pulse distribution (that is to say a distribution having a shape that a Gaussian shape may approximate) and is called a useful pulse (UP).

In embodiments, the processing circuit (MT) is implemented by software instructions executed by the processing unit (UT).

The time-of-flight sensor (SENS) typically comprises an internal memory (MEM), adapted to be accessed by the processing unit (UT), namely, the processing circuit (MT).

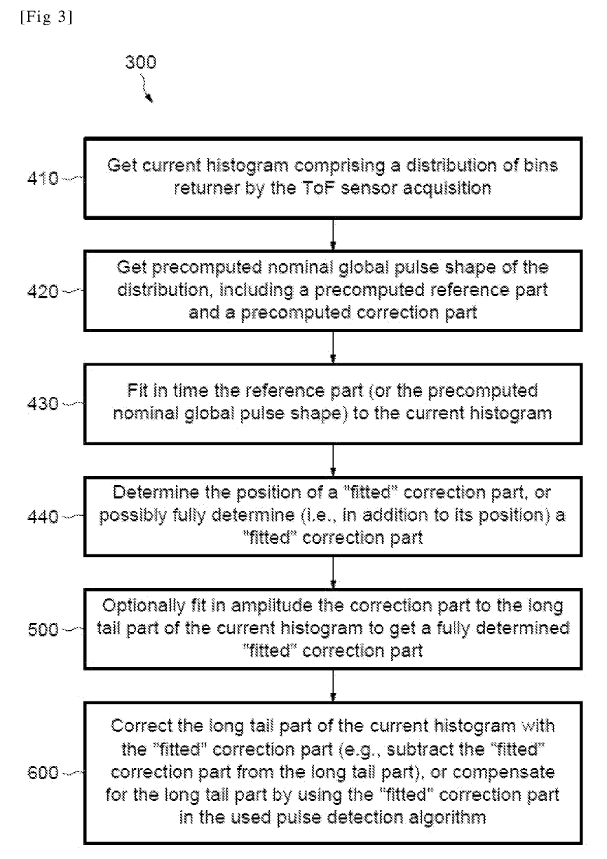

In particular, the processing circuit (MT) is configured to receive the histogram generated by the histogram generation circuit (MGH) and to carry out method 300 for detecting the presence of at least one object described concerning FIG. 3.

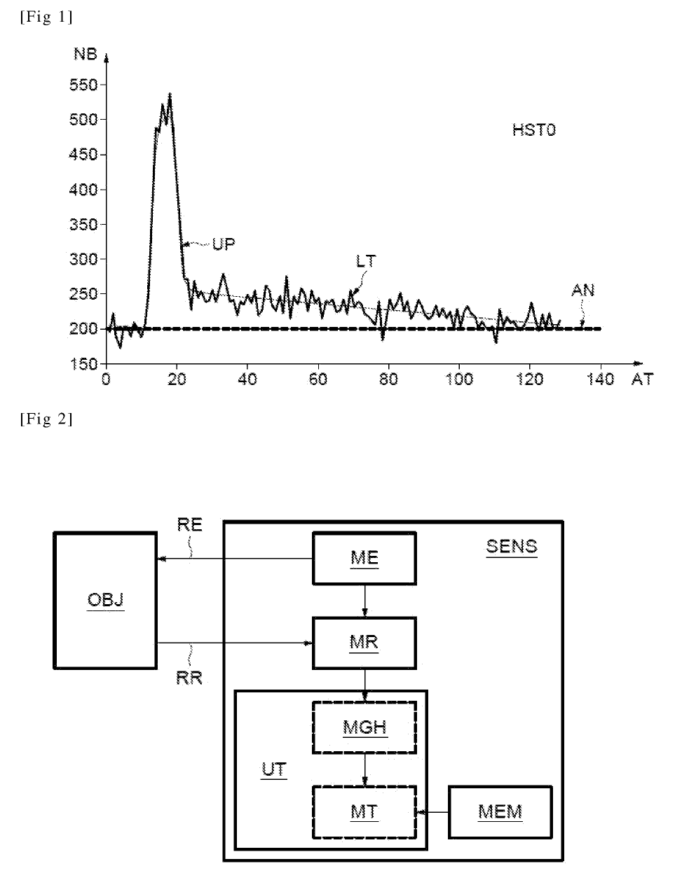

The method 300 includes particular steps that are designed to be able to correct (e.g., to suppress or compensate for) the undesirable long tail (LT) distribution (as described in relation with FIG. 1). The detecting and correcting (e.g. suppressing or compensating) method 300 may be performed in the pipeline processing of the ToF sensor (SENS), as a signal processing between the “raw” frame acquisition by the pixel array and the output of a distance map.

FIG. 3 illustrates a flowchart of an embodiment method 300 for detecting the presence of at least one object. Implementation of method 300 starts by obtaining, at a step 410, a current histogram (HST) generated by the time-of-flight sensor (SENS) as described above in relation to FIG. 1. The histogram (HST) accordingly comprises a distribution of bins associating a number of detected photons (NB) to a given acquisition time (AT).

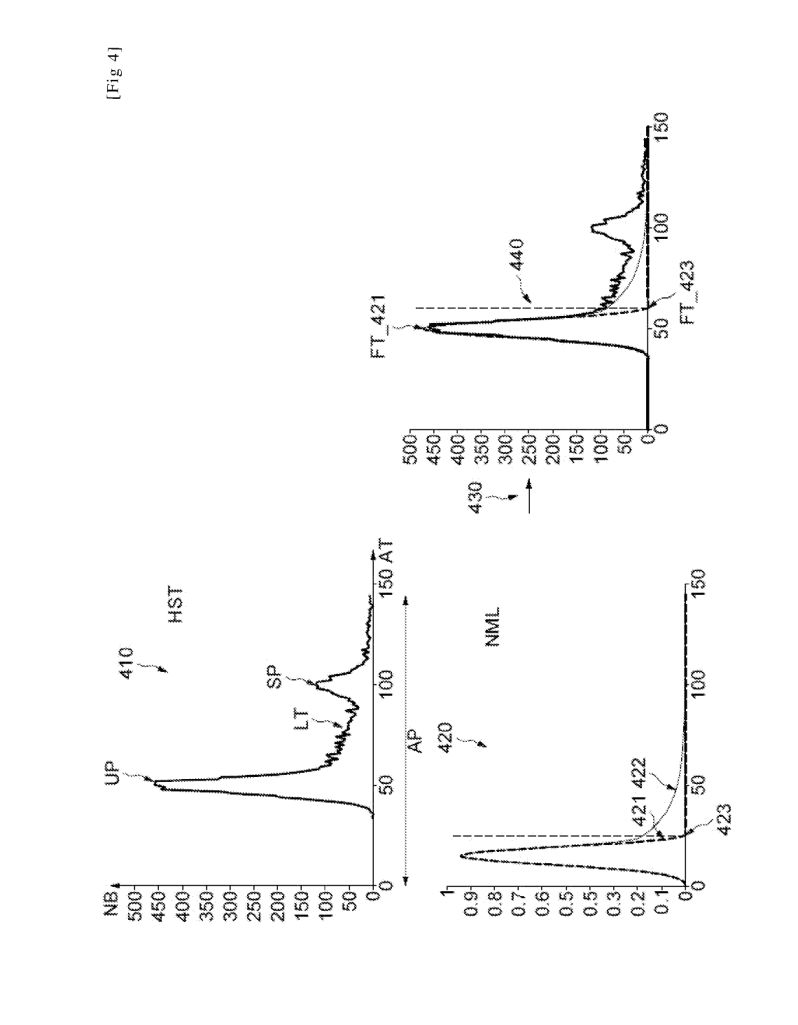

The method includes, at a step 420, providing a precomputed nominal global pulse shape of the distribution, including a reference part 421 (FIG. 4) and a correction part 422 (FIG. 4).

The method includes, at a step 430, performing a fitting in time (that is to say the position along the abscissa axis of acquisition time (AT)) of the precomputed reference part (or possibly of the precomputed nominal global pulse shape) to the current histogram (HST).

At step 440, the method includes determining the position of the long tail (LT) part of the current histogram (HST). This determination uses the known position 423 of the correction part 422 relative to the reference part 421 inside the precomputed nominal global pulse shape.

FIG. 4 depicts example implementations for steps 410, 420, 430, and 440 of method 300. Hence, the current histogram (HST) returned by the ToF sensor acquisition at step 410, may result from emitting an optical radiation (RE) (FIG. 2), counting photons detected from an optical radiation (RR) (FIG. 2), and generating the current histogram (HST) according to the count of detected photons (NB) over respective acquisition time (AT), the acquisition times succeeding each other during an acquisition period (AP) starting with the emission of the optical radiation (at “0”).

In this example of returned histogram (HST), the count (NB) ordinate axis has been shifted to position the ambient noise level at zero.

In this example, the current histogram (HST) includes a useful pulse (UP) distribution, a long tail (LT) distribution, and a secondary pulse (SP) distribution.

The useful pulse (UP) distribution is typical and representative of the presence of the object (OBJ) (FIG. 2) in the field of view of the sensor. The useful pulse (UP) distribution may correspond to, e.g. look like, a Gaussian distribution, centred on bin “50” corresponding to a first object distance, having a maximum magnitude of about “450” counts, and a width at half maximum of about 10 bins (ten unities of acquisition time (AT)).

The long tail (LT) distribution is not representative of an object's presence within the sensor's field of view. Still, it is an undesired effect of various phenomena in the emitter or the receiver. The typical long tail (LT) distribution has a shape of a progressive decreasing series of bins, starting on the right side of the useful pulse (UP), in this example at a magnitude of about “100” counts at bin “60,” or one fifth (1/5) of the maximum magnitude of the useful pulse. The long tail decreases to magnitude zero at the last bin, “144.” The decreasing shape may be expressed in various ways, like an exponential decrease, a hyperbolic decrease, or a linear decrease.

The secondary pulse (SP) distribution also represents the presence of another object in the sensor's field of view. The secondary pulse (SP) distribution may correspond to, e.g., look like, a Gaussian distribution, in this example, centred on bin “100” corresponding to a second object distance, having a maximum magnitude of about “100” counts, and a width at half maximum of about 10 bins. The secondary pulse (SP) distribution is superimposed on the long tail (LT) distribution. Consequently, cases with a lower max amplitude of such secondary pulses SP may be occulted by the long tail (LT) distribution.

At step 420, the precomputed nominal global pulse shape (NML) of the global distribution is provided. For example, the precomputed nominal global pulse shape (NML) is provided from the memory (MEM), possibly amongst a set of precomputed nominal global pulse shapes (NML) that are designed to match with various ranging conditions like various device temperatures.

From a general point of view, the precomputed nominal global pulse shape (NML) includes a reference part 421 adapted to match with a “normal” or “useful” contribution in the histogram of a given detection case with the same proportions as the typical useful pulse (UP) distribution described above.

The precomputed nominal global pulse shape (NML) also includes a correction part 422 designed to match with an undesired side effect, to be corrected, and involved by (or relating to) the said given detection case, such as a long tail shape 422 with same properties as described above concerning the typical long tail (LT) distribution.

For that purpose, in the present example, the precomputed nominal global pulse shape (NML) includes a useful pulse shape 421 with same properties as the typical useful pulse (UP) distribution described above, and a long tail shape 422 with same properties as the typical long tail (LT) distribution described above.

The useful pulse shape 421 and the long tail shape 422 in the precomputed nominal global pulse shape (NML) are conceived as two distinct but linked together parts. The useful pulse shape 421 is called reference part 421 because it will be used as a reference to fit to the current case, and the long tail shape 422 is called correction part 422 because it will be used as a corrective/compensating element of distribution.

At the step 430, we fit in time the reference part 421 (or possibly the nominal global pulse shape (NML)) to the current histogram (HST), the part of the current histogram (HST) with the highest amplitude being the useful pulse (UP) distribution of the current histogram (HST).

For that purpose, the fitting step 430 may firstly include an identification in the current histogram (HST) of the useful pulse (UP) representative of the presence of an object (OBJ), to be the part of the current histogram with the highest amplitude.

For instance, this identification may include a simple identification of the bin having the largest magnitude in the histogram.

The purpose of the fitting step 430 is to align the reference part 421 or the nominal global pulse shape (NML) with the useful pulse (UP) distribution of the current histogram (HST) in time.

In other words, in a first act, at step 430, the reference part 421 or the nominal global pulse shape (NML) is positioned to fit in time to the useful pulse (UP), that is to say to design a “fitted” reference part (FT_421) which aligns as much as possible in time with the shape of the useful pulse (UP) distribution in the current histogram (HST).

Several techniques can be used for fitting in time 430 the reference part 421 or the nominal global pulse shape (NML) to each current case UP, such as, for instance, a correlation technique using a precomputed super-resolution shape or a shifting technique to match the maximum of the current histogram (HST).

The correlation technique may use a precomputed super-resolution nominal global pulse shape (NML) of the global pulse or a precomputed super-resolution nominal shape of the useful pulse. A super-resolution shape is a shape with a finer resolution compared to the resolution of the acquisition time (AT) of the histograms generated by the histogram generation circuit (MGH). Such super-resolution shape can be obtained from ranging measurements with an appropriately configured time-of-flight device. The super-resolution shape is characterized by its up-sampling factor concerning the histograms generated by the histogram generation circuit (MGH). The higher this up-sampling factor (meaning the finer the resolution of the super-resolution shape), the more precise will be the alignment in time with the useful pulse (UP) distribution of the current histogram (HST).

The result of this correlation technique is the “fitted” reference part (FT_421), obtained in a position aligned with the current histogram.

Optionally, still at step 430, the alignment obtained for the “fitted” reference part (FT_421) can be applied to the nominal global pulse shape (NML), and the resulting aligned nominal global pulse shape can be further scaled to match in amplitude the useful pulse (UP).

The shifting technique may include a shift of the reference part 421 or the nominal global pulse shape (NML) to match the maximum of the current histogram (HST). The shifting technique includes determining the bin having the largest magnitude in the current histogram (HST) and shifting to this bin the center of the reference part 421.

The result of this shift is the “fitted” reference part (FT_421), obtained in a position aligned with the current histogram.

Optionally, still at step 430, the shift calculated for the “fitted” reference part (FT_421) can be applied to the nominal global pulse shape (NML) and the resulting shifted nominal global pulse shape can be further scaled to match in amplitude the useful pulse (UP).

In the example depicted in FIG. 4, the center of the reference part 421 is shifted to bin “50,” resulting in the “fitted” reference part (FT_421). The same shift is then applied to the nominal global pulse shape (NML), which is finally scaled by a factor adapted to reach about “450” counts at the maximum.

Also, the fitting step 430 can be done based on a nominal filtered global pulse shape on an equally filtered histogram (for example to use a less noisy histogram in the fitting step 430), using a post fitting adjustment coefficient to rescale the filtered shape to its unfiltered amplitude in case the shifted nominal filtered global pulse shape is further scaled to match in amplitude the useful pulse (UP).

At step 440, the position FT_423 of a “fitted” correction part FT_422 is determined, defined as the position of the long tail (LT) part of the current histogram (HST). The position of the long tail (LT) part of the current histogram (HST) is determined using the position, resulting from step 430, of the “fitted” reference part (FT_421) inside the current histogram (HST) and from the knowledge of the position 423 of the correction part 422 relatively to the reference part 421 inside the precomputed nominal global pulse shape (NML).

In other words, in a second act, at step 440, we obtain the position FT_423 of a “fitted” correction part FT_422 according to a fitting in time of the reference part 421 (or possibly the nominal global pulse shape (NML)) to the useful pulse (UP).

This advantageously offers the position FT_423 of a “fitted” correction part FT_422, according to a fitting in time performed on the useful pulse distributions UP whose shape is fixed and known, rather than on the global distributions of bins (i.e., the histograms) which may contain secondary pulses SP in their long tail (LT) distribution, which can make the fitting less precise.

For example, determining 440 the position FT_423 of the “fitted” correction part FT_422 may include determining this position as the starting position of the long tail (LT) distribution, that is to say the position (at the bin or sub-bin resolution) where the long tail (LT) distribution starts inside the current histogram (HST). This starting position may be determined using the position of the “fitted” reference part (FT_421) inside the current histogram (HST) and the knowledge of the position 423 of the correction part 422 relatively to the reference part 421 inside the precomputed nominal global pulse shape (NML).

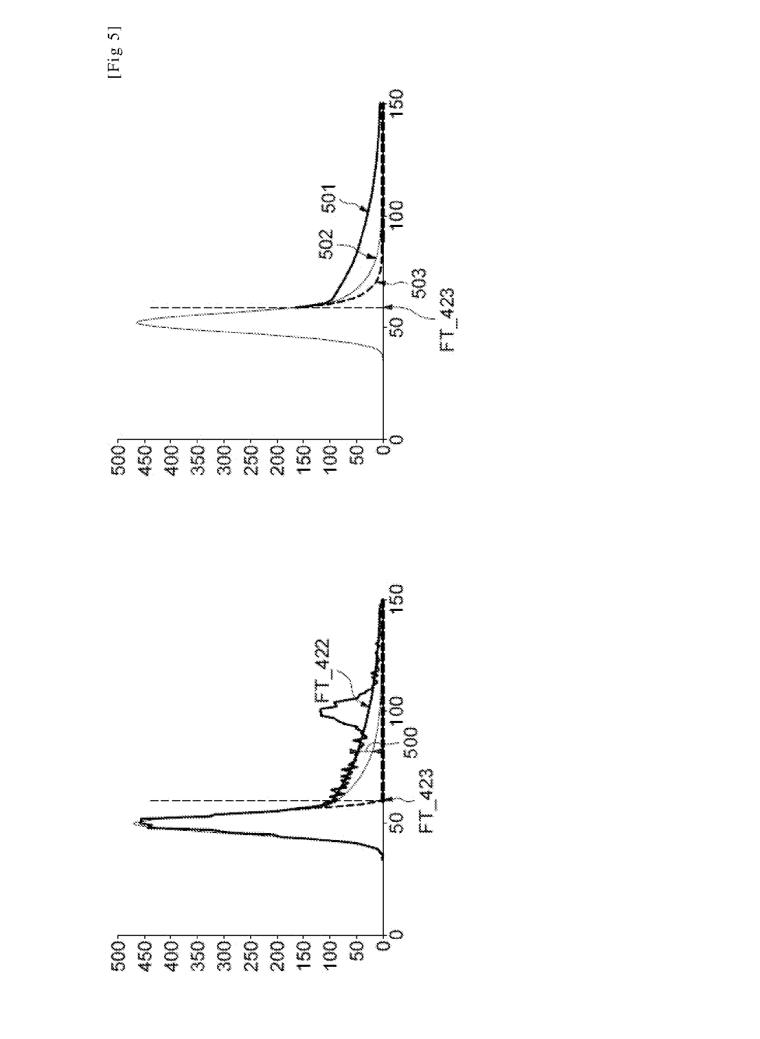

At step 440, the “fitted” correction part FT_422 can be fully determined (i.e., in addition to its position FT_423) if, at step 430, the nominal global pulse shape (NML) has been aligned (or shifted) and scaled to match in amplitude the useful pulse (UP). The “fitted” correction part FT_422 is then simply, inside the aligned (or shifted) and scaled nominal global pulse shape, the correction part 422 equally aligned (or shifted) and scaled (as depicted by FIG. 5).

If, at step 430, the nominal global pulse shape (NML) has not been aligned (or shifted) and scaled to match in amplitude the useful pulse (UP), then only the position Ft_423 of the “fitted” correction part FT_422 can be determined at step 440 and another step is required to fully determined the “fitted” correction part FT_422.

We now refer back to FIG. 3. After the mechanisms of steps 410, 420, 430 described in relation with FIG. 4, the method 300 may include a step 500 including a second fitting operation to fully determine the “fitted” correction part FT_422. This step 500 is optional in case the “fitted” correction part FT_422 has been fully determined at step 440.

FIG. 5 depicts the second fitting operation 500 of the correction part 422 to a long-tail part of the current histogram. The second fitting operation 500 includes first setting the correction part 422 at the position FT_423 determined at step 440 for the “fitted” correction part FT_422, and then matching in amplitude the correction part 422 with the long tail (LT) distribution.

The result of the fitting operation 500 is the “fitted” correction part FT_422 (i.e., the fully determined “fitted” correction part FT_422).

Several techniques can be used for the second fitting operation 500 such as, for instance, regression technique such as a root mean square (RMS) error regression, after having filtered out the points that are likely to belong to a secondary pulse (SP). Filtering out these points may be performed for instance with respect to the derivatives in the long tail (LT) region LT, detecting portions to eliminate, for instance rising and falling portions where the slopes are significantly different from the average slope in the long tail (LT) region LT. Another example, is a scaling technique, including scaling the correction part 422 with the scale factor that permits the “fitted” reference part (FT_421) to match in amplitude the useful pulse (UP).

For the second fitting operation 500, different precomputed known functions (501, 502, 503, …) depending on the device temperature could also be used as the correction part (422).

We refer back to FIG. 3. The method 300 finally includes a step 600 correcting the long tail (LT) part of the current histogram (HST) either by removing (or subtracting) the “fitted” correction part FT_422 from the current histogram, or compensating for the long tail (LT) part by using the “fitted” correction part FT_422 in the pulse detection algorithm (such as for instance by making a detection threshold varying according to the “fitted” correction part FT_422 variations).

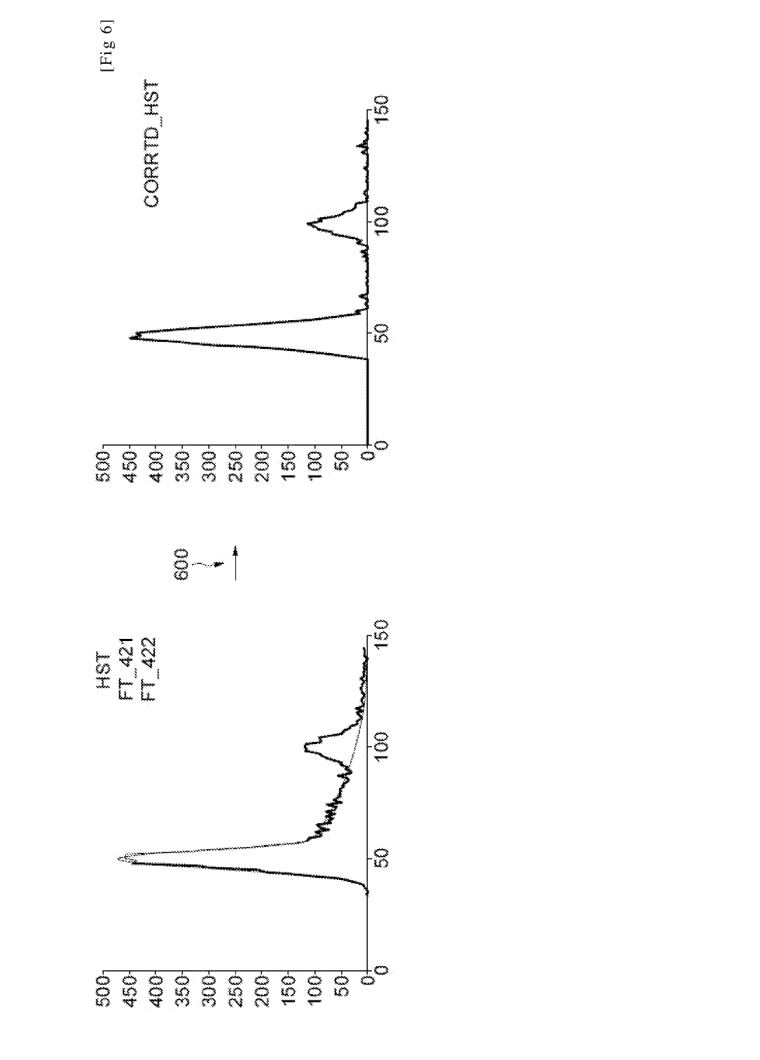

FIG. 6 depicts the subtracting option for the correcting operation 600. The left side of FIG. 6 depicts a superimposition of three graphs: the graph drawing the returned histogram (HST), the graph drawing the “fitted” reference part (FT_421) derived from the precomputed reference part 421, and the graph drawing the “fitted” correction part FT_422 derived from the precomputed correction part 422.

The right side of FIG. 6 depicts a graph drawing the corrected current histogram (CORRTD_HST), which is the current histogram (HST) from which the “fitted” correction part FT_422 have been removed (subtracted) from its long tail (LT) part.

As a result, the undesirable long tail (LT) distribution may be precisely corrected in the current histogram (HST), as the corrected current histogram (CORRTD_HST) shows clear and distinct the useful pulse (UP) and the secondary pulse (SP).

In consequence, further (post-)processing, for example performed by the processing circuit (MT), may be highly improved by being performed on such corrected current histograms (CORRTD_HST), such as for example the detection of the presence of object(s) in the field of view, possibly of a plurality of objects at different distances from the sensor.

In resume, it has been described embodiments that are configured so as to be able to separate the global pulse shape into a precomputed reference part and a precomputed correction part and use the “fitted” reference part to get the position of the “fitted” correction part; possibly adjust the precomputed correction part to the long tail part of the current histogram by a second fitting in amplitude; and subtract from the long tail part of the current histogram an estimate of the undesired long tail (LT) distribution (or compensate for this distribution by using its estimate in the used pulse detection algorithm), this estimate being the “fitted” correction part.

In other words, a very effective correction or compensation of undesired distribution elements in the histograms (long tail (LT) distributions) is carried out by using a precomputed global pulse or a precomputed shape of the useful pulse (UP), called the reference part, to remove from the long tail part of the currently returned histogram an estimate of the long tail (LT) distribution, this estimate being calculated from the precomputed shape of the long tail, called the correction part, or to compensate for this distribution by using its estimate in the used pulse detection algorithm, by performing at least one fitting (in time) with the precomputed global pulse shape or the reference part of it and possibly a separate second fitting (in amplitude) with the correction part of it.

What is claimed is:

1. A method for detecting a presence of at least one object within a field of view of a time-of-flight sensor, comprising:
obtaining a current histogram generated by the time-of-flight sensor, the histogram comprising a distribution of bins associating a number of detected photons to a given acquisition time;
generating a precomputed nominal global pulse shape of the distribution, including a reference part and a correction part;
performing a fitting of the position of at least the reference part to the current histogram;
determining the position of a long tail part of the current histogram using the position of the correction part relatively to the reference part inside the precomputed nominal global pulse shape;
calculating an estimate of a long tail distribution in the current histogram from the precomputed correction part and the determined position; and
performing a correction, in the current histogram, of the calculated estimate of the long tail distribution.

2. The method of claim 1, wherein performing a fitting of the position includes an alignment in time of the entire nominal global pulse shape with the current histogram.

3. The method of claim 1, wherein performing a fitting of the position comprises:
identifying, in the current histogram, a useful pulse representative of the presence of an object; and
aligning the position of the reference part with the useful pulse of the current histogram.

4. The method of claim 1, further comprising performing a fitting in amplitude of the correction part to the long tail part of the current histogram.

5. The method of claim 1, wherein the reference part of the precomputed nominal global pulse shape includes a shape of a nominal useful pulse.

6. The method of claim 1, wherein the correction part of the precomputed nominal global pulse shape includes a shape of a nominal long tail with a progressively decreasing series of bins.

7. The method of claim 1, further comprising:
emitting an optical radiation;
counting photons detected from a reflected optical radiation; and
generating the current histogram according to the count of detected photons over respective acquisition times, the acquisition times succeeding each other during an acquisition period starting with the emission of the optical radiation.

8. A system for detecting a presence of at least one object within a field of view, comprising:
a time-of-flight sensor
a non-transitory memory storage comprising instructions; and
a processor in communication with the time-of-flight sensor and the non-transitory memory storage, wherein the processor executes the instructions to:
generate a current histogram comprising a distribution of bins associating a number of detected photons to a given acquisition time,
generate a precomputed nominal global pulse shape of the distribution, including a reference part and a correction part,
perform a fitting of the position of at least the reference part to the current histogram,
determine the position of a long tail part of the current histogram using the position of the correction part relatively to the reference part inside the precomputed nominal global pulse shape,
calculate an estimate of a long tail distribution in the current histogram from the precomputed correction part and the determined position, and
perform a correction, in the current histogram, of the calculated estimate of the long tail distribution.

9. The system of claim 8, wherein performing a fitting of the position includes an alignment in time of the entire nominal global pulse shape with the current histogram.

10. The system of claim 8, wherein performing a fitting of the position comprises:
identifying, in the current histogram, a useful pulse representative of the presence of an object; and
aligning the position of the reference part with the useful pulse of the current histogram.

11. The system of claim 8, wherein the processor executes the instructions to perform a fitting in amplitude of the correction part to the long tail part of the current histogram.

12. The system of claim 8, wherein the reference part of the precomputed nominal global pulse shape includes a shape of a nominal useful pulse.

13. The system of claim 8, wherein the correction part of the precomputed nominal global pulse shape includes a shape of a nominal long tail with a progressively decreasing series of bins.

14. The system of claim 8, further comprising:
an emitter configured to emit an optical radiation; and
a receiver configured to count photons detected from a reflected optical radiation, wherein the processor includes a histogram generator configured to generate the current histogram according to the count of detected photons over respective acquisition times, the acquisition times succeeding each other during an acquisition period starting with the emission of the optical radiation.

15. A non-transitory computer-readable media storing computer instructions that, when executed by a processor coupled to a time-of-flight sensor, cause the processor to:
generate a current histogram comprising a distribution of bins associating a number of detected photons to a given acquisition time,
generate a precomputed nominal global pulse shape of the distribution, including a reference part and a correction part,
perform a fitting of the position of at least the reference part to the current histogram,
determine the position of a long tail part of the current histogram using the position of the correction part relatively to the reference part inside the precomputed nominal global pulse shape,
calculate an estimate of a long tail distribution in the current histogram from the precomputed correction part and the determined position, and
perform a correction, in the current histogram, of the calculated estimate of the long tail distribution.

16. The non-transitory computer-readable media of claim 15, wherein performing a fitting of the position includes an alignment in time of the entire nominal global pulse shape with the current histogram.

17. The non-transitory computer-readable media of claim 15, wherein performing a fitting of the position comprises:
identifying, in the current histogram, a useful pulse representative of the presence of an object; and
aligning the position of the reference part with the useful pulse of the current histogram.

18. The non-transitory computer-readable media of claim 15, wherein the instructions, when executed by the processor, cause the processor to perform a fitting in amplitude of the correction part to the long tail part of the current histogram.

19. The non-transitory computer-readable media of claim 15,
wherein the reference part of the precomputed nominal global pulse shape includes a shape of a nominal useful pulse, and
wherein the correction part of the precomputed nominal global pulse shape includes a nominal long tail with a progressively decreasing series of bins.

20. The non-transitory computer-readable media of claim 15, wherein the instructions, when executed by the processor, cause the processor to:
control emission of an optical radiation;
process data representing counted photons detected from a reflected optical radiation; and
generate the current histogram according to the count of detected photons over respective acquisition times, the acquisition times succeeding each other during an acquisition period starting with the emission of the optical radiation.
